(19) United States
(12) Patent Application Publication
(10) Pub. No.: US 2007/0260502 A1
(43) Pub. Date: Nov. 8, 2007

(54) Project resource plans

(75) Inventors: Rahul N. Motwani, Redmond, WA (US); Jesse G. Carnathan, Seattle, WA (US); Nichol C. Viton, Seattle, WA (US); Roy T. Kayahara, Toronto (CA)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/417,803

(22) Filed: May 4, 2006

(51) Int. Cl. G06F 9/46

(52) U.S. Cl. 705/9

(57) ABSTRACT

Project management software allows for the creation of resource plans, where resources are allocated to projects without assigning tasks to the resources. Resource plans allow for a proposed or committed status for each resource. A resource plan may be used in conjunction with an associated project plan, allowing resources to be “reserved” to assigning tasks. Resource utilization calculations may be performed using either (or both) a detailed project plan or a resource plan.

### BACKGROUND

Project management software enables project managers, resource planners, and other participants to create, manage, and view the resources and tasks required to complete projects. Resources can include people, facilities, assets, materials, and so forth. Project management software can be used by an enterprise to assign tasks to a limited set of resources for a variety of projects. Such software can track resource utilization, on-time task completion, and other project variables in order to offload such tracking from project managers, freeing them to spend more time planning and managing projects.

Existing project management software solutions do not enable users to schedule resources into the future without detailed task assignments. Resources may be scheduled and have tasks assigned, or they may be unscheduled. When planning for the future, existing solutions do not allow project and resource planners to speculatively schedule specific resources for projects that are merely proposed and/or for which no tasks may yet be identified.

It is with respect to these and other considerations that the present invention has been made.

### SUMMARY

This summary is provided to introduce a selection of concepts in a simplified form that are further described below in the detailed description. This summary is not intended to identify key features or essential features of the claimed subject matter, nor is it intended as an aid in determining the scope of the claimed subject matter.

Embodiments provide for receiving project resource information for use in a resource plan having no assigned tasks. Instead, numeric allocations (e.g., hours, days, FTEs) are associated with the resources for a fixed interval of time (e.g., days, weeks, months). Resource plan information may be utilized for calculating resource utilization values. Resource plans may be published and stored on a server.

These and other features and advantages will be apparent from a reading of the following detailed description and a review of the associated drawings. It is to be understood that both the foregoing general description and the following detailed description are explanatory only and are not restrictive of the invention as claimed.

### BRIEF DESCRIPTION OF THE DRAWINGS

The foregoing brief summary of the invention, as well as the following detailed description, is better understood when read in conjunction with the accompanying drawings, which are included by way of example, and not by way of limitation with regard to the claimed invention. In the accompanying drawings, the same or similar elements are labeled with the same reference numbers.

FIG. 1 depicts an exemplary computing operating environment.

FIG. 2 depicts a conception of a resource plan.

FIG. 3 depicts an interface for manipulating a resource plan.

FIG. 4 depicts a resource plan and a related project plan.

FIG. 5 depicts an entity-relationship diagram for a resource plan.

FIG. 6 depicts a method for creating or modifying a resource plan.

### DETAILED DESCRIPTION

Project management software includes functionality for creating project resource plans permitting allocation of resources (specified and/or unspecified) to projects without tasks.

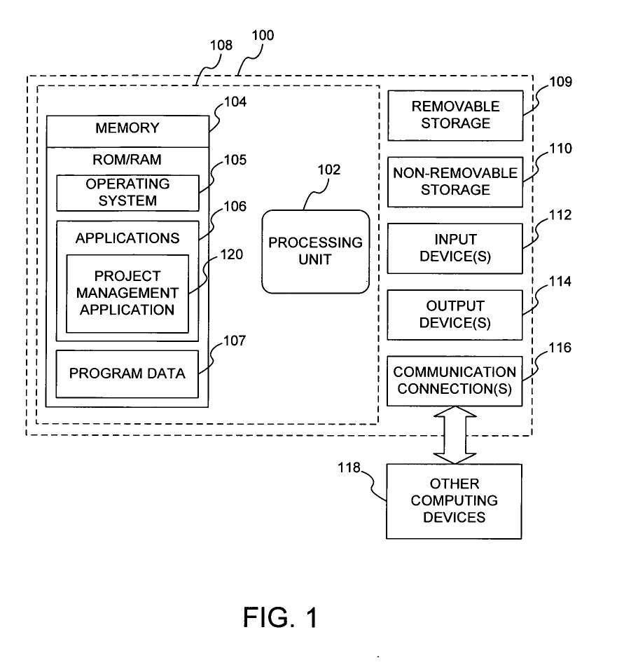

With reference to FIG. 1, an embodiment may include a computing device, such as computing device 100. In a basic configuration, computer device 100 may include at least one processing unit 102, and memory 104. Depending on the configuration of the computer device, memory 104 may be volatile (e.g., Random Access Memory (RAM)), non-volatile (e.g., Read-Only Memory (ROM), Flash, etc.), or some combination thereof. Memory 104 may serve as a storage location for operating system 105, one or more applications 106, and may include program data 107, as well as other programs. In one embodiment, applications 106 may include project management application 120.

Although the basic computing device configuration is contained within dashed-line box 108, computing device 100 may include additional features and functionality. For example, computing device 100 may include additional data storage components, including both removable storage 109 (e.g., floppy disks, memory cards, compact disc (CD) ROMs, digital video discs (DVDs), external hard drives, universal serial bus (USB) key drives, etc.) and non-removable storage 110 (e.g., magnetic hard drives).

Computer storage media may include media implemented in any method or technology for storage of information, including computer readable instructions, data structures, program modules, or other data. Memory 104, removable storage 109, and non-removable storage 110 are all examples of computer storage media. Further examples of such media include RAM, ROM, electrically-erasable programmable ROM (EEPROM), flash memory, CD-ROM, DVD, cassettes, magnetic tape, magnetic disks, and so forth. Any such computer storage media may be accessed by components which are a part of computing device 100, or which are external to computing device 100 and connected via a communications link (e.g., Bluetooth, USB, parallel, serial, infrared, etc.). Computing device 100 may also include input devices 112, such as keyboards, mice, pens, microphone, touchpad, touch-display, etc. Output devices 114 may include displays, speakers, printers, and so forth. Additional forms of storage, input, and output devices may be utilized.

Computing device 100 may also include one or more communication connections 116 which allow the computing device to communicate with other computing devices 118, such as over a network (e.g., a local area network (LAN), the Internet, etc.). Communication media, in the form of computer readable instructions, data structures, program modules, or other data in a modulated data signal, may be shared with and by device 100 via communication connection 116. Modulated data signal may mean a signal that has one or more of its characteristics set or changed in such a manner as to encode information in the signal, and may include a modulated carrier wave or other transport mechanism. Communication connection 116 may be comprised of hardware and/or software enabling either a wired (e.g., Ethernet, USB, Token Ring, modem, etc.) or wireless (e.g., WiFi, WiMax, cellular, acoustic, infrared, radio frequency (RF), etc.) communication conduit with other devices 118.

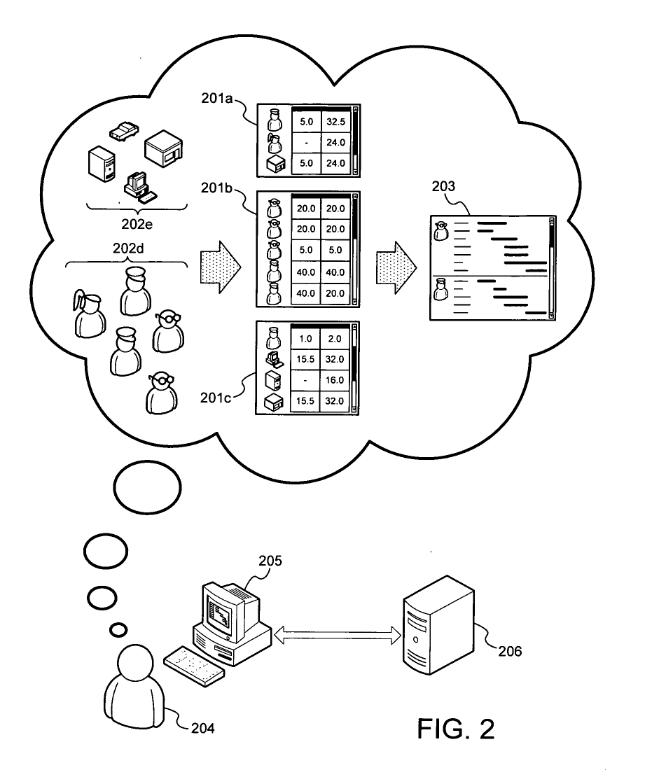

FIG. 2 depicts a user 204 conceiving a resource plan 201. User 204 works with project management application 120 using computer 205, which may resemble computing device 100 above. User 204 may be a project manager, a resource planner, or any other person responsible for planning resource allocations associated with projects. User 204 may wish to plan the use of resources 202, ultimately assigning resources to project plan 203.

Computer 205 may work with server 206 which may also resemble computing device 100. Server 206 may serve and store project management information and logic. For example, project management application 120 may be installed as a software application on computer 205. Application 120 may work with data locally, storing project data on a hard drive. Application 120 may also work with data remotely stored on server 206 in a data store, for example, a database. Server 206 may also house project management application 120, and user 204 may access an interface to the application using computer 205. For example, user 204 may utilize a web browser to access an interface of project management application 120.

In a multi-user environment, data constituting resource plan 201 may be checked in and checked out by users for modification, locking the data while editing, preventing multiple incompatible changes to the data. The use of resource plan 201 by multiple users may be facilitated through the use of an application programming interface (API) including methods for creating, reading, updating, deleting, publishing, checking out, and checking in resource plans from server 206.

Before assigning resources to project 203, user 204 may wish to flesh out resource allocations in a speculative or un-specified fashion. A project may be conceived, but project tasks may not be determined or assigned. In addition, specified resources (e.g., named individuals) may be unknown, although required skills or job titles may be known. Nevertheless, user 204 may wish to associate resources with a project so as to experiment with future resource allocations for one or more projects. To allocate resources to a project without assigning tasks, user 204 may utilize resource plans 201.

Here, user 204 may be deciding among multiple projects by experimenting with resource plans 201. Resource plans 201 may utilize people 202d and/or assets & materials 202e. Resource plan 201a, for example, may include two named individuals (e.g., “Tom G.” & “Sarah K.”) and a building/facility (e.g. “Main Street Retail Building/Facility”), among other resources. Resource plan 201b, as another example, may include several unnamed job titles (e.g., 3 “Accountants” & 2 “Engineers”). Resource plan 201c, as a third example, may include a named individual (e.g., “Tom G.” again), a computer, a server, and a location.

User 204 may assign the same resource 202 to multiple resource plans 201 as part of the planning process. In some embodiments, project management application 120 may automatically prevent over-allocating resources to resource plans. Alternatively, resources may be over-booked, especially when marked as “proposed”. A resource plan 201 may also include time allocations for which resources are being allocated. For example, a resource may be scheduled for 5 hours for one week, and 32.5 hours the next week. Alternatively, a project participant may be scheduled using full-time equivalents, so 1.0 for a full time worker, and 0.5 for a half-time worker. Resources may be scheduled on a “proposed” or “committed” basis, depending on how sure the planner is that the resource can and will be assigned to the project. Project plan 203 may retain a relationship with an associated resource plan, allowing users to plan future resource requirements in the resource plan, and plan individual task assignments in the project plan.

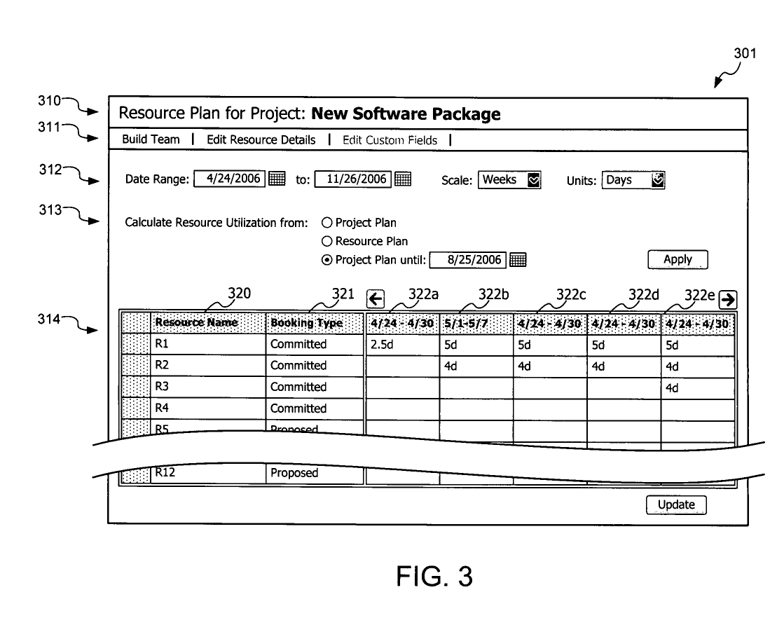

FIG. 3 depicts an example of an interface 301 for creating and modifying a resource plan 201. Interface 301 may be presented to a user as a portion of a web browser displayed on computer 205. Interface 301 may also be presented to a user as a portion of a software application window. The particulars of the interface shown are not required and are merely supplied as an example.

Title 310 displays the name of the project plan 203 with which the currently displayed resource plan 201 is associated. Menu 311 provides a series of actions which may be performed with respect to the current resource plan 201. Included here are options to “Build Team” which may invoke an interface for adding and removing resources 202 to the current resource plan 201. “Edit Resource Details” may invoke an interface for edit the details of a resource 202. “Edit Custom Fields” may invoke an interface for editing, adding, and removing custom fields to be associated with resources in the current project. For the items in menu 311 (and for other interface items), user 204 may have greater or fewer privileges for invoking the various functions. When user 204 does not have a privilege for a particular function (e.g., editing resource details), the associated item may be disabled.

Interface controls 312 enable a user to modify the current view of the resource plan. “Date Range” inputs allow a user to filter the dates being currently viewed and/or modified in columns 322 of table 314. Dates may be specified exactly as shown here, in addition to other methods, such as selecting project milestones. “Scale” permits a user to adjust the time scale for columns 322. Here, the scale is set to ‘Weeks’, and thus each column 322 represents one week. Additional choices may include ‘Days’ and ‘Months’. The “Units” control determines the units of resource allocation that are displayed in columns 322. Here, the scale is set to ‘Days’, and thus for each resource and for each column, the number of days of work planned for that time period is displayed. Other choices include ‘Hours’ and ‘FTEs’ (Full-time Equivalents). Modifying either the scale or units selection may require a recalculation in order to convert time and allocation accordingly.

“Calculate Resource Selection From” control 313 enables a user to select whether resources allocated to this project/resource plan should use the resource plan or the project plan for displaying and determining their utilization. If a user selects “Project Plan”, then when determining a resource's utilization, time allocated to this project will be based on the project plan and the tasks assigned to that resource. For “Resource Plan”, any assigned tasks in the project plan are ignored, and the resource's utilization is based strictly on the resource plan. The third choice permits a hybrid of project plan and resource plan. User 204 can signify that resource utilization determinations be based on the project plan until a specified date, at which point the resource plan may be used. In this fashion, a project plan need only be accurate up until the specified date, at which point the resource plan can act as a fall-back or estimated outlook for resource utilization.

Column 320 of table 314 identifies resources in each row. The resource may be either named (e.g., “Tom G.”) or generic (e.g., “Software Engineer”). Each row may also include a booking type 321, identifying the status of the allocation of the resource (proposed, committed, etc.). Although not shown in FIG. 3, table 314 may also have additional columns for additional fields, including custom resource fields specified for the project. If updates are made to resource allocations in table 314 (and user 204 has the appropriate privileges), the changes may be made to the underlying data store automatically, or alternatively via an “Update” button or similar control.

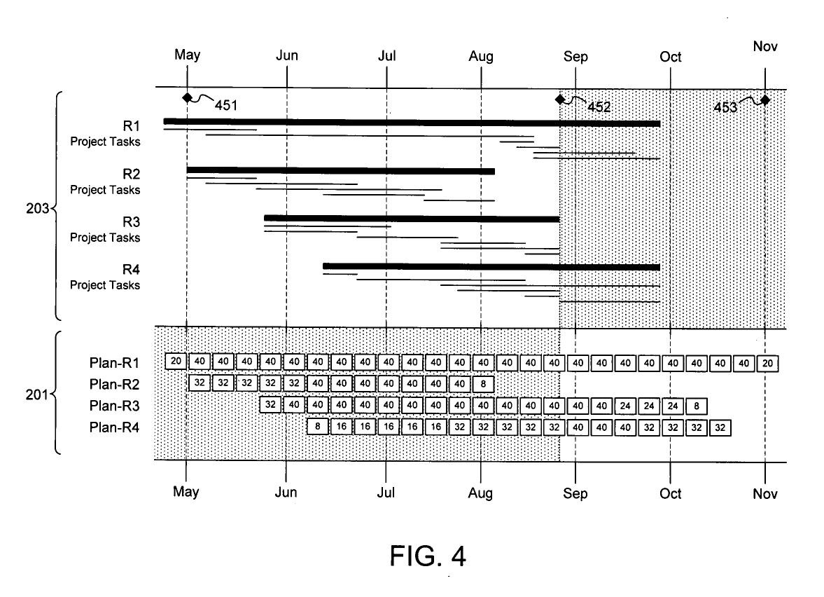

FIG. 4 depicts a comparison of a project plan 203 and a resource plan 201. Project plan 203 includes four resources R1-R4, each having multiple tasks assigned. Project plan 203 includes milestones 451-453, each of which corresponds to key dates associated with the project (e.g., software beta launch). Resource plan 201 is associated with project plan 203. Resource plan 201 may provide a non-specific allocation of time (or FTE proportion) each resource is expected to spend on the project. Here, resource plan 201 shows weekly time allocations in hours. Project plan 203, on the other hand, may assign each resource a specific set of tasks and indicate time both planned for and spent on the project. Here, as indicated on interface 301, for resource utilization purposes, project plan 203 is used up until August 25 (milestone 452), at which time the allocations outlined in resource plan 201 will be used for utilization calculations.

Having the ability to reserve resources using a resource plan can prove valuable to planners who create project plans that include only tasks without assigning them to resources (i.e. a task-only project). The resources can be reserved by using a resource plan with estimates of time requirements for named resources during the duration of the project. In this fashion, the named resources (e.g., “Tom G.” and “Sarah K.”) can be reserved as utilized despite the fact that they are not assigned to tasks on the project plan. In this example, the planner indicates that the “Calculate Resource Utilization From” property is set to “Resource Plan” for the project.

For planners who are evaluating multiple projects, resources can be assigned to resource plans in advance of project approval. The assignments may have a booking type of “proposed”, for example. In this fashion, resource utilization can be evaluated across multiple proposed projects so as to arrive at an optimum combination of projects and assigned resources. At such a point, resource plans may be “promoted” to full fledge project plans having tasks assigned. Likewise, resource planners may be able to view the pool of future and/or proposed projects and resources. If a demand for a particular job title or set of skills exceeds current capacity, the resource planner can requisition additional headcount.

As resource plans are fleshed out in their accompanying project plans, the resource plan can be modified to more accurately reflect likely future needs. For example, if a resource plan called for 1.0 FTEs for a particular month, but the actual resource need for that month turned out to be 1.5 FTEs, then a project or resource planner can update future months in the resource plan to more accurately reflect the demand for resources.

In conjunction with the above-noted uses of resource plans, data stored in conjunction with resource plans, along with associated project plan data can be made available for reports or a reporting system. For example, a reporting system may access resource and project data to determine and track performance to budget for a project. Such data may also be used to automatically generate utilization reports for multiple projects. Resource plan data may be used for additional reports as needed.

Resource plans may be modified in draft form until such time as a planner decides to publish the resource plan. In this fashion, others will not be confused by resource plans which are a work in progress. Instead, other users will only see published versions of a resource plan as a planner continues to modify the most recent draft. In addition, when making utilization calculations, resource plans which have been published may be used as a basis for making calculations.

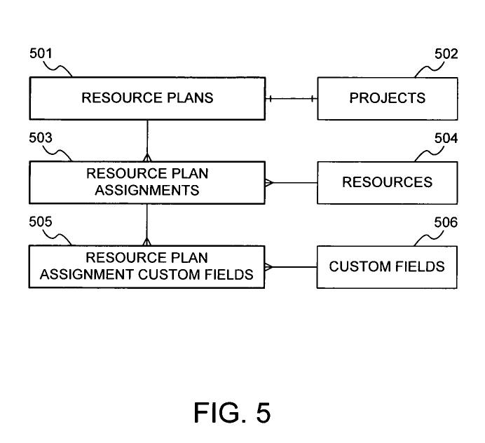

FIG. 5 depicts an example of an entity-relationship diagram enabling resource plans. In a client-server environment, or in a standalone software application, a project management application may need new data entities, and/or programming objects. The entities shown in FIG. 5 may represent programming objects, database tables, software components, and so forth. As shown in FIG. 5, a project entity 502 has a 1-to-1 relationship with a resource plan entity 501. Multiple resource entities 504 can be assigned to multiple resource plan entities 501 via resource plan assignment entities 503. Likewise, multiple custom field 506 values can be associated with resource plan assignment entities 503 via resource plan assignment custom field entities 505.

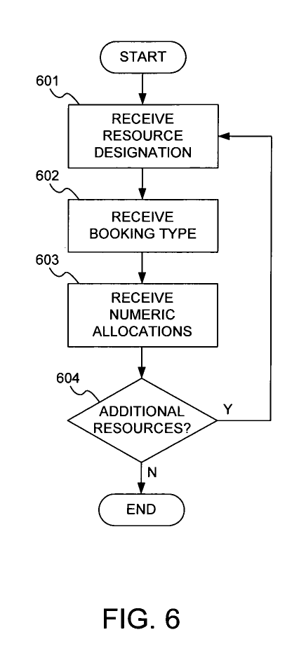

FIG. 6 depicts a method for creating or modifying a resource plan. At 601, a designation for a resource is received. This may be a named resource, a job title, a needed skill, and so forth. At 602, for the designated resource, a booking type is specified which may include a value of proposed or committed. At 603, numeric allocations for the resource are received, each one corresponding to a day, a week, or a month, depending on the current view of the resource plan. If, at 604, additional resources are to be added to the resource plan, then the logic returns to 601. Otherwise, the method terminates normally.

While methods and systems embodying the present invention are shown by way of example, it will be understood that the invention is not limited to these embodiments. The methods and systems described are merely examples of the invention, the limits of which are set forth in the claims which follow. Those skilled in the art may make modifications, particularly in light of the foregoing teachings.

We claim:

1. A computer-implemented method for associating resources with a project within a project management software application, the method comprising:
receiving a plurality of resources to associate with the project without assigning tasks to any of the plurality of resources;
receiving a plurality of numeric allocations for each of the plurality of resources, wherein each of the numeric allocations corresponds to a fixed period of time;
associating a booking type with each resource, wherein the booking type includes one of confirmed and proposed; and
receiving a plurality of task assignments, wherein each task is assigned to one of the plurality of resources.

2. The computer-implemented method of claim 1, the method further comprising:
calculating resource utilization values for each of the plurality of resources, wherein resource utilization is calculated using the plurality of numeric allocations.

3. The computer-implemented method of claim 1, the method further comprising:
receiving a transition date;
calculating resource utilization values prior to the transition date using the plurality of task assignments; and
calculating resource utilization values following the transition date using the plurality of numeric allocations.

4. The computer-implemented method of claim 1, wherein the plurality of resources comprises named individuals.

5. The computer-implemented method of claim 1, wherein the plurality of resources comprises one of a job title and a needed skill.

6. The computer-implemented method of claim 1, wherein the fixed period of time comprises one of a day, a week, and a month.

7. The computer-implemented method of claim 6, wherein the numeric allocations comprise time values.

8. The computer-implemented method of claim 6, wherein the numeric allocations comprise full-time equivalent values.

9. The computer-implemented method of claim 1, the method further comprising:
creating a published version of the plurality of numeric allocations for each of the plurality of resources; and
allowing further changes to an unpublished version of the plurality of numeric allocations for each of the plurality of resources.

10. A system for testing software, wherein the system comprises:
a processor;
a memory, storing instructions executable by the processor, wherein the instructions comprise:
receiving a resource to associate with a project without assigning tasks to the resource;
receiving a plurality of numeric allocations for the resource, wherein each of the numeric allocations corresponds to a fixed period of time;
associating a booking type with the resource, wherein the booking type includes one of confirmed and proposed;
receiving a plurality of task assignments, wherein each task is assigned to at least one of the plurality of resources;
receiving a transition date;
calculating resource utilization values prior to the transition date using the plurality of task assignments; and
calculating resource utilization values following the transition date using the plurality of numeric allocations.

11. The system of claim 10, wherein the resource is a named individual.

12. The system of claim 10, wherein the resource is one of a job title and a needed skill.

13. The system of claim 10, wherein the fixed period of time comprises one of a day, a week, and a month.

14. The system of claim 13, wherein the numeric allocations comprise time values.

15. The system of claim 13, wherein the numeric allocations comprise full-time equivalent values.

16. The system of claim 10, further comprising:
a network interface enabling communication between the processor and a remote computer, wherein the remote computer includes a data store; and
wherein the instructions further comprise:
sending the plurality of numeric allocations for the resource to the data store via the network interface.

17. The system of claim 16, wherein the instructions further comprise:
checking out the plurality of numeric allocations for the resource from the data store for exclusive editing;
modifying the plurality of numeric allocations for the resource; and
checking in the plurality of numeric allocations for the resource to the data store.

18. The system of claim 10, wherein the instructions further comprise:
creating a published version of the plurality of numeric allocations for the resource; and
allowing further changes to an unpublished version of the plurality of numeric allocations for the resource.

19. A computer-implemented method for modifying a resource plan associated with a project, the method comprising:
retrieving the resource plan from a server;
receiving a resource for allocation to the resource plan, wherein the resource has no tasks assigned;
receiving a selection of a booking type for the allocated resource, wherein the booking type comprises one of proposed and committed;
receiving a numeric allocation for the allocated resource, wherein the numeric allocation is associated with a fixed period of time;
saving the modified resource plan to the server; and
receiving a request to publish the resource plan.

20. The computer-implemented method of claim 19, further comprising:
retrieving a project plan from the server, wherein the project plan is associated with the resource plan;
assigning a task to the resource for the project plan;
saving the modified project plan to the server.
